(19) United States
(12) Patent Application Publication
(10) Pub. No.: US 2025/0337066 A1
(43) Pub. Date: Oct. 30, 2025

(54) BATTERY SYSTEM INCLUDING IMPROVED CELL COVER ATTACHMENT

(71) Applicant: SAMSUNG SDI CO., LTD., Yongin-si (KR)

(72) Inventor: Florian TRIPAUM, Wolfau (AT)

(21) Appl. No.: 18/813,918

(22) Filed: Aug. 23, 2024

(30) Foreign Application Priority Data
Apr. 26, 2024 (EP) 24172665.2

(51) Int. Cl. H01M 50/186; H01M 50/249; H01M 50/276; H01M 50/342; H01M 50/367

(52) U.S. Cl. CPC H01M 50/186; H01M 50/249; H01M 50/276; H01M 50/3425; H01M 50/367

(57) ABSTRACT

A battery system includes: a plurality of battery cells, each of the battery cells having a venting exit for discharging a venting gas stream at a venting side thereof; and a cover element covering at the venting side of at least one of the plurality of battery cells to protect the battery cell from the venting gas stream. The cover element is directly sealed to the venting side of the battery cell by an adhesive extending around the venting exit.

### CROSS-REFERENCE TO RELATED APPLICATION

The present application claims priority to and the benefit of European Patent application Ser. No. 24172665.2, filed on Apr. 26, 2024, in the European Patent Office, the entire disclosure of which is incorporated herein by reference.

### BACKGROUND

### 1. Field

Aspects of embodiments of the present disclosure relate to a battery system.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle “BEV”) or may include a combination of an electric motor and, for example, a conventional combustion engine (a so-called Plugin Hybrid Electric Vehicle “PHEV”). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (e.g., is accommodated in) a casing, and electrode terminals, which are positioned on the outside of the casing, establish an electrically conductive connection to the electrodes. The casing may have, for example, a cylindrical or rectangular shape.

A battery module is formed of a plurality of battery cells connected together in series or in parallel. For example, the battery module is formed by interconnecting the electrode terminals of the plurality of battery cells, in a number and configuration depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or respectively the battery cells, may be configured in a series, parallel, or a mixture of both to provide the desired voltage, capacity, and/or power density. Components of a battery pack include the individual battery modules and interconnects, which provide electrical conductivity between the battery modules.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the energy stored is released very suddenly. In extreme cases, thermal runaway can cause battery cells to explode and start a fire. In minor cases, it can cause battery cells to be damaged beyond repair.

When a battery cell is heated above a critical temperature (e.g., above about 150° C.) the battery cell can transition into thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is therefore flammable and potentially toxic. The vented gas also causes gas-pressure to increase inside the battery pack. In the worst case, the high temperatures lead to the process (e.g., the thermal runaway) spreading to neighboring cells and a fire in the battery pack. At this stage, the fire is difficult to extinguish.

A battery management system (BMS) is critical to the safe operation and optimal performance of rechargeable battery cells and reduces or minimizes the possibility of thermal runaway. For example, if the BMS detects that the temperature is too high, it can regulate the temperature by controlling cooling fans. If the battery cell cannot be sufficiently cooled and safe conditions restored, the BMS may shut down necessary battery cells to protect the entire system.

A conventional venting concept for a battery module is to let the venting gas stream discharged from the battery cell(s) expand into the battery housing and escape through a housing venting valve to the outside (e.g., to the environment surrounding the battery housing). This concept, however, causes the venting gas stream to heat up the components inside the battery housing, such as the other battery cells. Furthermore, particles from the venting gas stream may deposit onto the battery cells, which may lead to thermal propagation and may incite thermal runaway in adjacent battery cells. To protect the battery cells, a cover element may be provided covering at the venting side of the battery cells.

Such a cover element may have venting openings in the form of through-holes that are aligned with venting exits in the battery cells to let the venting gas stream pass through the cover element in case of a thermal runaway of one of the covered battery cells. After passing through the cover element, particles of the discharged venting gas stream may deposit onto the cover element. However, particles of the venting gas stream may pass through another venting opening of the cover element that is aligned with the venting exit of another one of the battery cells and may contact (or enter) the other battery cell. This may lead to thermal propagation of the other battery cell and, in the worst case, incite a thermal runaway in the other battery cell.

To address this problem, a cover element may be provided that is thin enough to rupture at sections aligned with and corresponding in shape with the venting exits of the battery cells when exposed to the high pressure of the venting gas stream exiting one of the covered battery cells affected by a thermal runaway. Also, the cover element may, at sections aligned with the venting exits, include perforations corresponding to the venting exits to provide a breaking point (e.g., a predetermined breaking point) that may rupture when exposed to the high pressure of the venting gas stream. The cover element is often adhered to the surface of the battery cells via two adhesive strips that extend in straight lines along a stacking direction of the battery cells to span multiple battery cells, with one adhesive strip being disposed on each side of the venting exits of the battery cells.

These solutions, however, risk that the cover element may be bent outwardly by the pressure of the venting gas stream before the cover element ruptures, causing the cover element to lift off the battery cells adjacent to the affected battery cell so that venting gas might possibly flow underneath the cover element towards the adjacent battery cells. In this case, the two adhesive strips may form a tunnel for the venting gas stream extending along the surfaces of the battery cells from one battery cell to the next. This may lead to thermal propagation in the adjacent battery cells and, in the worst case, incite a thermal runaway in the adjacent battery cells.

### SUMMARY

According to embodiments of the present disclosure, a battery system that more securely handles a thermal runaway of one or more of its battery cells is provided.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes a plurality of battery cells, each of the battery cells having a venting exit for discharging a venting gas stream at a venting side thereof, and a cover element covering the venting side of at least one of the plurality of battery cells to protect the battery cell from the venting gas stream. The cover element is directly sealed to the venting side of the battery cell by an adhesive extending around the venting exit.

According to an embodiment of the present disclosure, the cover element may be formed in one piece from a sheet material.

According to an embodiment of the present disclosure, the cover element may be a mica sheet.

According to an embodiment of the present disclosure, the adhesive may be on the entire venting side surfaces of the battery cells, except for the areas around the venting exits.

According to an embodiment of the present disclosure, the adhesive may include an adhesive bead.

According to an embodiment of the present disclosure, the adhesive may include a gap filler.

According to an embodiment of the present disclosure, the cover element may be configured to rupture at a section opposite the venting exit due to the discharged venting gas stream exiting the covered venting exit.

According to an embodiment of the present disclosure, the cover element may have material weakening portions opposite the venting exits of the battery cells.

Another embodiment of the present disclosure provides an electric vehicle including the battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view of a battery system according to an embodiment.

FIG. 2 is a schematic cross-sectional view of the battery system shown in FIG. 1.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a plurality of battery cells. The battery cells may be accommodated inside a battery housing of the battery system. The battery cells may be arranged, or stacked, along a stacking direction to form one or more cell stacks. The battery cells may be interconnected via an electrical connector, for example, busbars, contacting respective electrode terminals of the battery cells to form one or more battery modules/battery packs. The battery cells may be arranged to form one or more battery packs. In the battery pack, the battery cells may be electrically interconnected, for example, in series and/or in parallel, as described above. Multiple of these battery packs may form a battery module. The battery cells may be, for example, prismatic or cylindrical cells.

Each of the battery cells includes a venting exit at a venting side of the battery cell, which may be a terminal side of the battery cells at where the electrode terminals of the battery cells are disposed. Each venting exit is configured to allow for a venting gas stream to be discharged from the respective battery cell during a thermal runaway of the corresponding battery cell. Venting valves may be provided at (or in) the venting exits, which may open (e.g., may burst) upon a reference pressure (e.g., a predetermined pressure) being exceeded.

The battery system further includes a heat-resistant cover element, or cover sheet, that is arranged to cover one or more of the plurality of battery cells at their venting sides. For example, the cover element may cover multiple, or all, of the plurality of battery cells at their venting sides. In some embodiments, the cover element may span, or extend over, all of the battery cells. In other embodiments, multiple cover elements may be provided, with each covering one or a group of the battery cells. The cover element may cover the top side of the battery cell(s). The cover element is directly sealed to each battery cell by an adhesive extending around a periphery of (e.g., surrounding) each of the venting exits. For example, the cover element is adhered to the surface of each battery cell via the adhesive. The adhesive may continuously extend around each venting exits (e.g., The adhesive may extend around each venting exits uninterrupted). For example, each of the venting exits may be surrounded by an uninterrupted line of adhesive. The adhesive may be applied to the venting sides (e.g., to a top side) of the battery cells such that it surrounds each of the venting exits. For example, the adhesive may be applied in the form of multiple beads, or lines, each surrounding the venting exits.

The cover element, according to embodiments of the present disclosure, is securely adhered to the venting sides of the battery cells via the adhesive extending around each of the venting exits. This provides for a secure sealing in every direction. For example, due to the adhesive extending around each of the venting exits, each one of venting exits is sealed off from the other venting exits such that there is no passage for a venting gas stream that exits one of the venting exits that would lead to another battery cell. In other words, no tunnel extending along the surfaces of the battery cells from one battery cell to the next (e.g., under the cover element) is provided for the venting gas stream. Further, the sealing surrounding the venting exits ensures that the cover element is not bent outwardly, or lifted off, by the pressure of the venting gas stream, for example, when the cover element is configured to rupture at sections opposite the venting exits of the battery cells when exposed to the pressure of the venting gas stream exiting one of the covered battery cells affected by a thermal runaway. Thus, thermal propagation to adjacent battery cells and a thermal runaway of the adjacent battery cells is reliably prevented.

According to an embodiment, the cover element is formed in one piece (e.g., is integrally formed) from a sheet material. That is, the cover element may be formed from a single piece of sheet material. This provides for simple manufacturing of the cover element. Also, the cover element may be securely adhered to the battery cells via the adhesive and may allow for the cover element to rupture at sections opposite the venting exits.

According to an embodiment, the cover element is a mica sheet. That is, the sheet material may be a mica sheet. In other words, the cover element may be formed in one piece from a mica sheet. The cover element may, thus, include mica. Mica refers to mica silicate minerals. Such mica sheets are heat-resistant so that the cover element may withstand any particles from the venting gas stream being deposited onto the cover element. Also, such a mica sheet may be a suitable material for allowing the cover element to rupture at sections opposite the venting exits.

According to an embodiment, the entire venting side surfaces of the battery cells, aside from the areas around the venting exits, are provided with the adhesive. For example, the adhesive may cover the complete venting sides (e.g., the complete or entire top side) of the battery cells. Thus, the cover element may be securely sealed onto the entire surface to provide a secure and reliable sealing of the cover element to the battery cells, which may prevent lift off of the cover element.

According to an embodiment, the adhesive is (or includes) an adhesive bead. A bead refers to a bulge or line. For example, the adhesive may be applied in the form of a line. Each of the venting exits may be surrounded by such an adhesive bead. In other words, the adhesive may include a plurality of adhesive beads, with adhesive beads respectively extending around one of the venting exits. Providing the adhesive in the form of adhesive beads extending around the venting exits may provide a secure and reliable sealing of the cover element to the battery cells, which may prevent lift off of the cover element.

According to an embodiment, the adhesive is or includes a gap filler. The gap filler may be, for example, a polyurethane, such as SEPUR 114 FR THIXO+DK 001 by Demak Group. By using a gap filler as an adhesive (e.g. in the form of adhesive beads extending around the venting exits), a secure and reliable sealing of the cover element to the battery cells may be ensured and lift off of the cover element may be prevented.

According to an embodiment, the cover element is configured to rupture at a section opposite (e.g., aligned with) the venting exits due to the pressure of the discharged venting gas stream exiting the covered venting exit. The cover element may be configured by having a specific maximum thickness (e.g., by being thin enough to be ruptured by the venting gas stream). According to an embodiment, the cover element includes material weakening portions, for example, perforations, opposite the venting exits of the battery cells. These material weakening portions may ensure that the cover element ruptures at a section opposite the venting exits. Thus, the cover element may, at sections opposite the venting exits, include perforations corresponding to the venting exits to provide a breaking point (e.g., a predetermined breaking point) that may rupture when exposed to the high pressure of the venting gas stream. This may ensure that the venting gas stream can exit the underlying battery cell that is affected by the thermal runaway. Due to the adhesive extending around the venting exits, the cover element is nevertheless securely held at the battery cells without lift-off.

Embodiments of the present disclosure also provide an electric vehicle including a battery system as described herein, for example, as a traction battery.

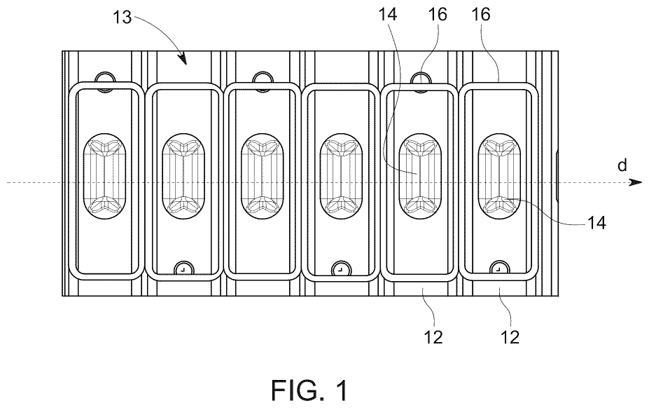

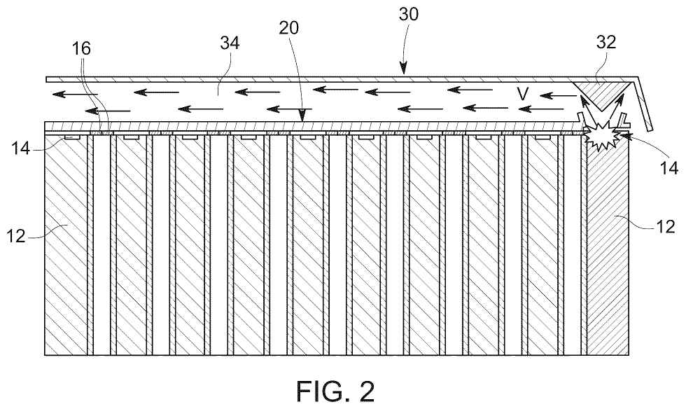

FIG. 1 is a top view of a battery system 100 according to an embodiment of the present disclosure without a cover element 20 (see, e.g., FIG. 2). The battery system 100 includes a plurality of battery cells 12 arranged along a stacking direction d. Each of the battery cells 12 has, at a venting side thereof, a venting exit 14 for discharging a venting gas stream V in case of a thermal runaway. Each of the venting exits 14 may include a venting valve. The venting sides of the battery cells 12 form a top side 13 of the battery cells 12.

Each of the venting exits 14 is surrounded (e.g., surrounded in a plan view) by an adhesive 16 forming an uninterrupted line (e.g., the adhesive 16 extends around a periphery of the venting exit 14). The adhesive 16 may be a gap filler. The adhesive 16 may be or may include an adhesive bead. A bead may refer to a bulge or line. The adhesive 16 seals the cover element 20 onto the top side 13 of the battery cells 12 (see, e.g., FIG. 2).

FIG. 2 is a cross-sectional view of the battery system 100 showing the

plurality of battery cells 12 covered by the cover element 20. The cover element 20 may be formed in one piece (e.g., may be integrally formed) from a mica sheet. The cover element 20 may include perforations corresponding to the venting exits 14 (e.g., at sections opposite or aligned with the venting exits 14) to provide a breaking point (e.g., a predetermined breaking point) that may rupture when exposed to the venting gas stream V (e.g., when exposed to the pressure of the venting gas stream V).

The cover element 20 is directly sealed to the top side 13 (e.g., the venting side) of the battery cells 12 via the adhesives 16, which extend around the periphery of each of the venting exits 14.

Referring to FIG. 2, a situation in which a thermal runaway occurs in the rightmost battery cell 12 resulting in a venting gas stream V being discharged from the venting exit 14 of the rightmost battery cell 12 is illustrated. The cover element 20 is ruptured by the venting gas stream V at a section opposite (e.g., aligned with) the venting exit 14 as shown in FIG. 2. The venting gas stream V may be diverted by a protrusion 32 extending from a wall member 30, which may form part of a battery housing, and may be directed along a venting channel 34 formed by (or formed between) the wall member 30 and the cover element 20.

The adhesives 16 surrounding each venting exit 14 provide a circumferential sealing that prevents the venting gas stream V from flowing between the top side 13 and the cover element 20 (e.g., prevents the venting gas stream V from flowing under the cover element 20) towards adjacent battery cells 12. For example, the adhesive 16 extend around each of the venting exits 14 such that each one of venting exits 14 is sealed off from the other venting exits 14 and no tunnel for the venting gas stream V extending along the surfaces of the battery cells 12 from one battery cell 12 to the next is generated as might be the case if the adhesive 16 were applied in straight lines spanning multiple battery cells 12.

Further, the adhesives 16 surrounding the venting exits 14 ensure that the cover element 20 is not bent outwardly, or lifted off, by the pressure of the venting gas stream V. Thus, thermal propagation to adjacent battery cells 12 and a thermal runaway of the adjacent battery cells 12 is reliably prevented.

### SOME REFERENCE SYMBOLS

12 battery cells
13 top side
14 venting exits
16 adhesive
20 cover element
30 wall member
32 protrusion
34 venting channel
100 battery system
V venting gas stream

What is claimed is:

1. A battery system comprising:
a plurality of battery cells, each of the battery cells having a venting exit for discharging a venting gas stream at a venting side thereof; and
a cover element covering at the venting side of at least one of the plurality of battery cells to protect the battery cell from the venting gas stream,
wherein the cover element is directly sealed to the venting side of the battery cell by an adhesive extending around the venting exit.

2. The battery system as claimed in claim 1, wherein the cover element is formed in one piece from a sheet material.

3. The battery system as claimed in claim 1, wherein the cover element is a mica sheet.

4. The battery system as claimed in claim 1, wherein the adhesive is on the entire venting side surface of the plurality of battery cells except for areas around the venting exits.

5. The battery system as claimed in claim 1, wherein the adhesive comprises an adhesive bead.

6. The battery system as claimed in claim 1, wherein the adhesive comprises a gap filler.

7. The battery system as claimed in claim 1, wherein the cover element is configured to rupture at a section opposite the venting exits due to the discharged venting gas stream exiting the covered venting exit.

8. The battery system as claimed in claim 7, wherein the cover element has material weakening portions opposite the venting exits of the battery cells.

9. An electric vehicle comprising the battery system as claimed in claim 1.
